(19) United States
(12) Patent Application Publication
(10) Pub. No.: US 2008/0118656 A1
(43) Pub. Date: May 22, 2008

(54) MASKING ARTICLE

(75) Inventors: Malcolm Douglas, Swansea (GB); Stephen J. Hollowell, Northampton (GB); Martyn Hagedorn, Swansea (GB); Gary Brotherton, Warwickshire (GB); Philip S. Hill, Leicestershire (GB)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/937,910

(22) Filed: Nov. 9, 2007

(30) Foreign Application Priority Data
Nov. 9, 2006 (GB) 0622340.8
Jun. 11, 2007 (GB) 0711124.8

(51) Int. Cl. B05D 3/00; B32B 3/00; B29C 65/06

(52) U.S. Cl. 427/444; 428/156; 156/73.5

(57) ABSTRACT

An elongate masking article (3), suitable especially for removable-attachment to a vehicle for masking a gap (15) between two relatively-movable parts (16, 18) of the vehicle, has an elongate transverse cross-section and is so constructed that an enclosed space (10) can be opened up within the article by applying pressure on opposite sides (6, 7) of the article to reduce the length of its transverse cross section, whereby the article is able to deform to fill the gap. The enclosed space (10) may be located between two layers of material that are arranged face-to-face and joined together along the said opposite sides (6, 7) of the article.

### CROSS REFERENCE TO RELATED APPLICATIONS

This application claims priority from Great Britain Application No. 0622340.8, filed Nov. 9, 2006 and Great Britain Application No. 0711124.8, filed Jun. 11, 2007, the disclosure of which is incorporated by reference in its/their entirety herein.

### FIELD OF THE INVENTION

This invention relates to masking articles of the kind that can be removably-attached to a vehicle for masking a surface to be painted. The invention relates more especially, but not exclusively, to masking articles that are suitable for masking a gap between two relatively-movable parts of a vehicle, to prevent paint or other surface treatment material that is being applied to the vehicle penetrating through the gap into the interior of the vehicle. The gap is typically associated with an opening in the vehicle, for example a door, boot or bonnet opening, and the surface treatment material is typically applied using some form of liquid-spraying apparatus.

### BACKGROUND

Masking materials are used to cover one area of an object while paint, or some other surface treatment material, is applied to an adjacent area. In the case of vehicles, such as cars, vans, lorries or caravans, masking materials are used most extensively (although not exclusively) when exterior surfaces of a vehicle are being painted, or otherwise treated, during repair or renovation.

In the following, for simplicity, the term “paint” will be used to include other similar surface treatment materials that are applied to the exterior surfaces of vehicles including, for example primers, anti-rust treatments, lacquers, and the term “painting” should be interpreted accordingly.

Particular difficulties arise when spray painting around gaps between relatively-movable parts of vehicles, such as the gaps between doors and the associated surrounds, because it is necessary to ensure that the paint does not get into the interior of the vehicle. It is also desirable to ensure that the paint does not accumulate in the vicinity of the gap to give an uneven finish. Various masking articles have previously been proposed to address these difficulties.

For example, it has been proposed to use a masking article in the form of an elongate foam tape to fill the gap between a movable part of the vehicle such as a door, hood/bonnet or trunk/boot and an adjacent part of the vehicle. The foam tape may have a longitudinally-extending stripe of pressure sensitive adhesive enabling the tape to be secured in the required position prior to painting and subsequently removed after painting. EP-A-0 384 626 describes a foam tape of that type having a pair of welded seams along its length such that the article has an oval or circular cross-section: the tape allows surfaces in the vicinity of a gap to be spray painted in such a way that the edge of the paintwork blends into the adjacent unpainted regions and unsightly paint ridges are avoided.

Other masking articles for use in gaps in vehicles are described in U.S. Pat. No. 5,260,097 (Silvestre); U.S. Pat. No. 5,885,395 (Western); U.S. Pat. No. 6,630,227 B1 (Himmelsbach et al.); U.S. Pat. No. 6,797,361 B1 (Bouic); WO 99/12654 (Jevons); and WO 02/068556 and WO 03/020438 (Jevtec Limited).

There is a wide variation in the dimensions and shapes of gaps in vehicles. For example, whereas earlier models of cars had shallow gaps between doors and frames, more recent models have smaller, deeper and staggered gaps. Similar changes have affected the gaps around boot and bonnet lids. Even within a single vehicle, the dimensions and shapes of the gaps around the doors may vary according to their location. For example, the gap between a front door of a vehicle and the “A” post (which supports the door hinges) may differ from the gap between that door and the “B” post (which supports both the catch for that door and the hinges for the rear door), and may differ again from the gap between the rear door and the “C” post (which supports the catch for the rear door).

It is desirable to have a masking article that is versatile enough to be used in a variety of gaps in vehicles whilst being comparatively easy to manufacture on a large scale and readily packaged.

In addition, when using certain adhesively-attached masking articles, it has been found possible to displace the article in such a way as to expose an edge of the adhesive to the paint spray. That, in turn, can result in an undesirable hard edge of paint being created where the paint accumulates against the edge of the adhesive.

Consequently, in the case of adhesively-attached masking articles, it is also desirable that the article should not be susceptible to displacement during use to expose the adhesive.

### SUMMARY OF THE INVENTION

The present invention provides an elongate masking article suitable for removable-attachment to a vehicle for masking a gap between two relatively-movable parts of the vehicle, the masking article having an elongate transverse cross-section and being so constructed that an enclosed space can be opened up within the article by applying pressure on opposite sides of the article to reduce the length of its transverse cross section, whereby the article is able to deform to fill the said gap.

In one type of article in accordance with the invention, the enclosed space is located between two layers of material that are arranged face-to-face and joined together along the said opposite sides of the article. Advantageously, the layers are joined together by welds, preferably welds that are formed by pressure without the input of heat, thereby facilitating manufacture.

Articles in accordance with the invention may be formed from any material known to be suitable for masking gaps in vehicle, including polymer foam.

In some embodiments, in which the masking article is formed from polymer foam, the polymer foam has an integral skin over at least a lengthwise extending part of the article. An integral skin may be located on an external surface of the article, enabling an improvement to be obtained in the appearance of the edge of a repainted area adjacent to that masked by the article. Alternatively, or in addition, an integral skin may be located on an internal surface of the article, facing the enclosed space, enabling the handling characteristics of the article to be modified.

Masking articles in accordance with the invention are not restricted to use in gaps and can also be used for masking swage lines on vehicles in preparation for repainting, or in blending newly painted regions of a vehicle body surface into regions having the original paint.

### BRIEF DESCRIPTION OF THE DRAWINGS

The accompanying drawings will be described below by way of example only. In the drawings:

FIG. 1 is a perspective view of a masking article in accordance with the invention;

FIG. 2 shows a diagrammatic transverse cross section of the masking article of FIG. 1;

FIG. 3 shows a similar cross section to FIG. 2 in the case in which pressure is applied to opposite sides of the masking article;

FIGS. 4A and 4B show schematic cross sections of the gap between the rear door and the ‘C’ post of vehicle, with the masking article of FIG. 1 in place, in the door ajar and door closed positions respectively;

FIGS. 5A and 5B show schematic cross sections of the gap between the bonnet and the surround of a vehicle, with the masking article of FIG. 1 in place and the bonnet in the slightly ajar and closed positions respectively;

FIG. 6 illustrates part of a process for making an array of the masking articles of FIG. 1;

FIG. 7 is a perspective view of an array made by the process;

FIGS. 8A and 8B respectively show a diagrammatic transverse cross section of part of another array of masking articles in accordance with the invention, and a close up view of part of one of the articles;

FIGS. 9A and 9B illustrate parts of a process for making the array of FIG. 8A; and

FIGS. 10 and 11 show diagrammatic transverse cross sections of other masking articles in accordance with the invention;

FIG. 12 is a diagram illustrating a process for forming an integral skin on a web of foam material;

FIG. 13 is a diagrammatic transverse cross-section of skinned foam material produced by the process illustrated in FIG. 12; and

FIGS. 14 to 16 show diagrammatic transverse cross sections of other masking articles in accordance with the invention.

### DETAILED DESCRIPTION

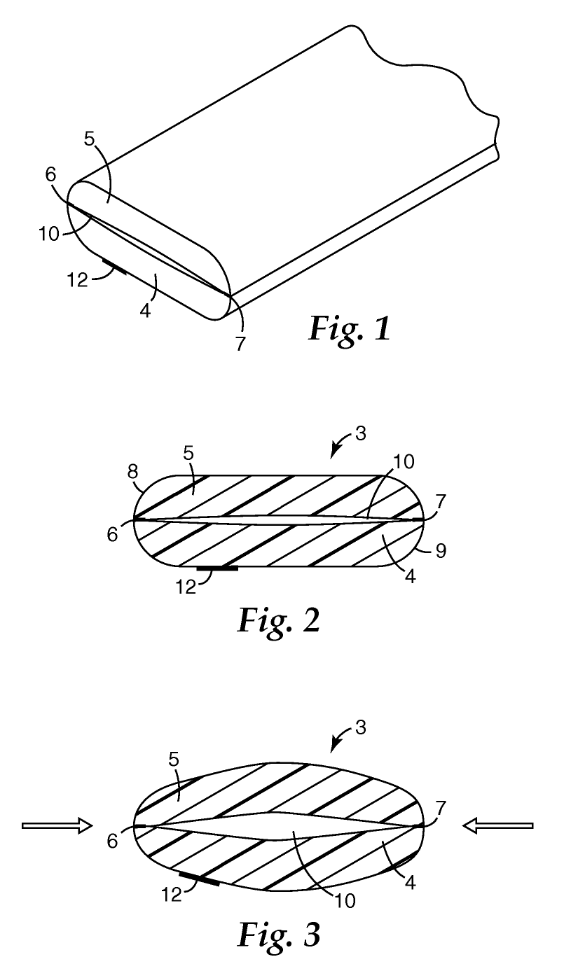

FIG. 1 shows an elongate masking article in the form of a flexible tape 3. The tape 3 comprises two elongate layers 4, 5 of resiliently-compressible foam material that are arranged face-to-face and joined together by longitudinally-extending welds 6, 7 on opposite sides of the tape. As shown also in FIG. 2, the cross-section of the tape 3 is elongated in the direction between the welds 6, 7, and is generally rounded at its ends 8, 9 in the vicinity of the welds.

The foam layers 4, 5 and welds 6, 7 enclose, in the centre of the tape 3, a space 10 that is almost closed when the tape is in the rest position because the layers 4, 5 lie comparatively close to each other. A pressure-sensitive adhesive stripe 12 is provided on the external surface of the tape and extends along the length of the latter. As illustrated, the adhesive stripe 12 is positioned closer to the weld 6 than to the weld 7.

The construction of the tape 3 (including its cross-sectional dimensions and the physical characteristics of the foam material of the layers 4, 5) are such that, when pressure is applied on opposite sides of the tape to move the welds 6, 7 towards one another, as indicated by the arrows in FIG. 3, the enclosed space 10 will open up and then eventually close again if the welds 6, 7 are moved far enough to be brought into contact with one another.

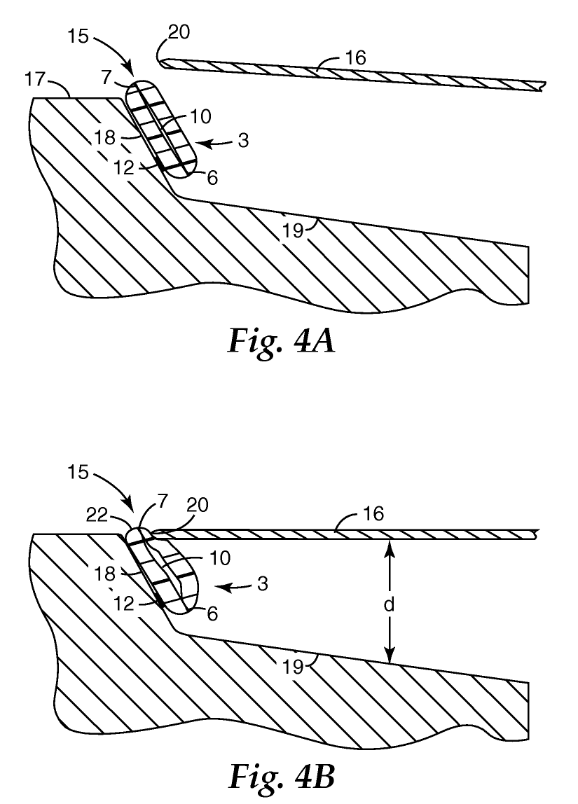

FIGS. 4A and 4B illustrate the use of the tape 3 to mask a gap 15 between a door 16 of a vehicle and an adjacent part, indicated at 17, in preparation for spray painting the exterior surfaces of the car during a repair operation. Depending on the nature of the repair operation, the tape 3 may be applied around the whole, or only a part, of the door opening and, in either case, the shape and dimensions of the gap to be masked may vary. In the particular case illustrated, the gap 15 is representative of that between the rear door and the quarter panel of certain modern cars in that the edge of the quarter panel adjacent the door is formed with a dog-leg comprising a surface 18 that extends inwardly from the gap to a wider, landing surface 19 that is more generally parallel to the door 16 when the latter is closed. The landing surface 19 may be spaced apart from the door 16 by a distance d of about 10 cm or more when the door is closed. The width of the gap 15 when the door is closed is typically at least 3 mm in a car and may be as large as 22 mm in a commercial vehicle.

As shown in FIG. 4A, the tape 3 is attached to surface 18 of the dog-leg of the quarter panel, with the door 16 slightly ajar. The tape 3 is positioned with the side defined by the weld 7 located in the vicinity of the gap 15 and the other side, defined by the weld 6, located away from the gap 15 towards the interior of the vehicle. The adhesive stripe 12, which is closer to the weld 6, is thus also located away from the gap 15. The door 16 is then closed, bringing the edge 20 of the door into contact with the masking tape 3 in the vicinity of the weld 7. The pressure exerted by the edge 20 of the door causes the space 10 to open up within the tape 3 while the latter partly folds around within, and fills, the gap 15 thereby masking the latter in preparation for spray-painting of the edge of the door and the adjacent surface 17. The surface 22 of the tape 3 that remains exposed in the gap 15 when the door 16 is closed enables a desirable “soft edge” to be obtained where the applied paint layer blends into the adjacent untreated surface, and the risk of the adhesive stripe 12 being exposed in the gap 15 and giving rise to a hard paint edge is comparatively low.

It has been found that the construction of the masking tape 3, which allows it to deform as described when pressure is applied at the sides of the tape (see FIG. 3), enables the tape to mask a greater variety of gaps between parts of vehicles than, for example, a solid tape. This, in turn, makes it possible for a single tape to be used to mask gaps in different vehicles, and also to mask a variety of gaps in a single vehicle. It will be appreciated that the extent to which, and the manner in which, the internal space 10 will open up inside the tape when the latter is in use can vary, depending on the nature of the gap that the tape is being used to mask. In some situations, the internal space 10 may even remain substantially closed.

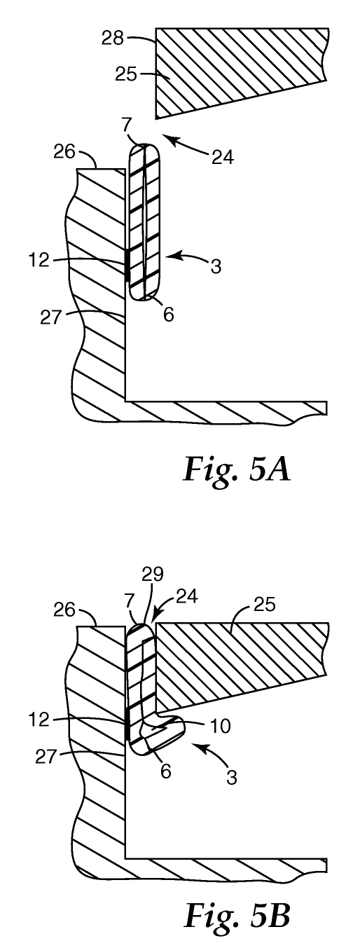

As a further example, FIGS. 5A and 5B illustrate the use of the masking tape 3 to mask the gap 24 between the bonnet 25 of a vehicle and its surround 26 in the case in which the surface 27 of the surround against which the bonnet closes extends inwards at approximately 90°. As shown in FIG. 5A, the tape 3 is attached to the surface 27 by the adhesive stripe 12, with the bonnet 25 slightly open. The tape is again positioned so that the side defined by the weld 7 is located in the vicinity of the gap 24 and the other side, defined by the weld 6, is located away from the gap 24 towards the interior of the vehicle. The adhesive stripe 12, which is closer to the weld 6, is thus also located away from the gap 15. The bonnet 25 is then closed bringing the edge 28 of the bonnet into contact with the masking tape 3 in the vicinity of the weld 7. The pressure exerted by the edge 28 of the bonnet causes the space 10 within the tape 3 to open up while the tape partly folds around within, and fills, the gap 24 thereby masking the latter in preparation for spray-painting of the edge of the bonnet and the surround 26. The surface 29 of the tape 3 that remains exposed in the gap 24 when the bonnet 25 is closed enables a desirable “soft edge” to be obtained where the applied paint layer blends into the adjacent untreated surface, and the risk of the adhesive stripe 12 being exposed in the gap 24 is practically non-existent.

It will be appreciated that, although the behaviour exhibited by the tape 3 in the situation illustrated in FIG. 5B is generally similar to the behaviour exhibited in the situation illustrated in FIG. 4B, the manner in which the space 10 opens up within the tape and the manner in which the tape folds around within the gap 15, 24 may be completely different in the two situations.

Since the position of the surfaces 18, 19 in FIGS. 4A and 4B and the surface 27 in FIGS. 5A and 5B are typical of the surrounds of many openings in modern vehicles, it will be appreciated that the same masking tape 3 could be applied to other vehicle openings, such as boots and other door openings. However, the tape can also be used effectively on older vehicles in which the gaps to be masked are typically less deep and have a different shape.

In some cases, the skilled user may prefer to attach the masking tape 3 to a surface in such a way that it protrudes to some extent from the gap and must then be pushed into the gap by hand. In that way, the skilled user can optimize the position of the tape within the gap, for example by running a finger along a selected length of the protruding tape.

As a further alternative, if appropriate, the masking tape 3 could be applied to the movable part of the vehicle (i.e. the door 16 in FIG. 4A or the bonnet 25 in FIG. 5A) rather than to the adjacent, non-movable part.

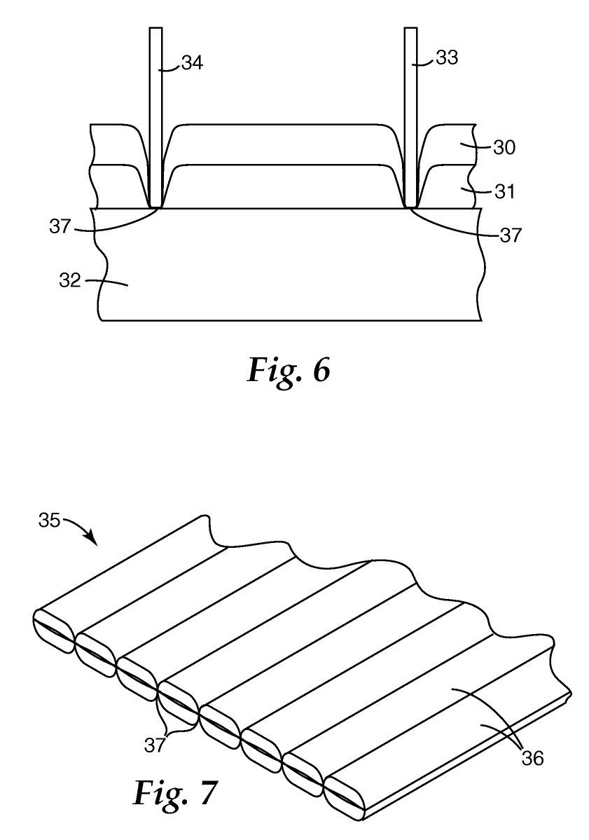

FIG. 6 illustrates part of the manufacture of an array of masking tapes of the type shown in FIG. 1. Two sheets 30, 31 of suitable foam material are passed together around a score roller 32. A set of equispaced rotary knives having blunt edges, of which only two 33, 34 are shown, is mounted on a bearing shaft (not shown) located to one side of the score roller 32 and is resiliently-biased towards the score roller with sufficient force to effect a set of parallel, equispaced welds 37 in the intervening foam sheets 30, 31 without actually cutting through the sheets. This type of weld, which is effected by pressure without the input of heat, is often referred to as a “cold weld”.

On the opposite side of the score roller 32, hot melt adhesive (not shown) is applied in a series of parallel stripes from a die (not shown) onto the external surface of the foam layer 30, between and in accurate alignment with, each pair of adjacent welds 37. The foam material, which now has the form of an array 35 of parallel foam strips 36 joined to one another by welds 37 as shown in FIG. 7, is taken up and wound into a roll either on itself or on a core. The ends of the foam strips 36 in the array can, if desired, be temporarily secured for packaging purposes by, for example, adhesive tabs (as described in EP-A-0 384 626), elastic ties (as described in WO 2005/110905), or staples. When required, any of the foam strips 36 can be separated for the desired length from the array 35 by tearing along the welds 37 that join it to adjacent strips: the separated foam strip has the form of the foam tape 3 shown in FIG. 1 and can be used, for example as described above, to mask a gap between two parts of a vehicle.

It will be appreciated that the width of foam tapes produced as described with reference to FIG. 6 can be adjusted by changing the distance between the rotary knives 33, 34, and that the position of the adhesive stripe on each tape can be adjusted by changing the positions of the die orifices relative to the rotary knives.

Particular examples of foam tapes of the type shown in FIG. 1, which have been found suitable for use in masking gaps in cars, have been made as described above with reference to FIG. 6 using sheets 30, 31 of cold-weldable polyurethane foam having a thickness of 3 mm and a density of either 26 kg/m³ or 36 kg/m³ available from Caligen Foams Limited, Broad Oak, Accrington, UK. The tapes were produced in widths (i.e. the distance between adjacent welds 37 in FIG. 6) of 14 mm, 22 mm and 30 mm.

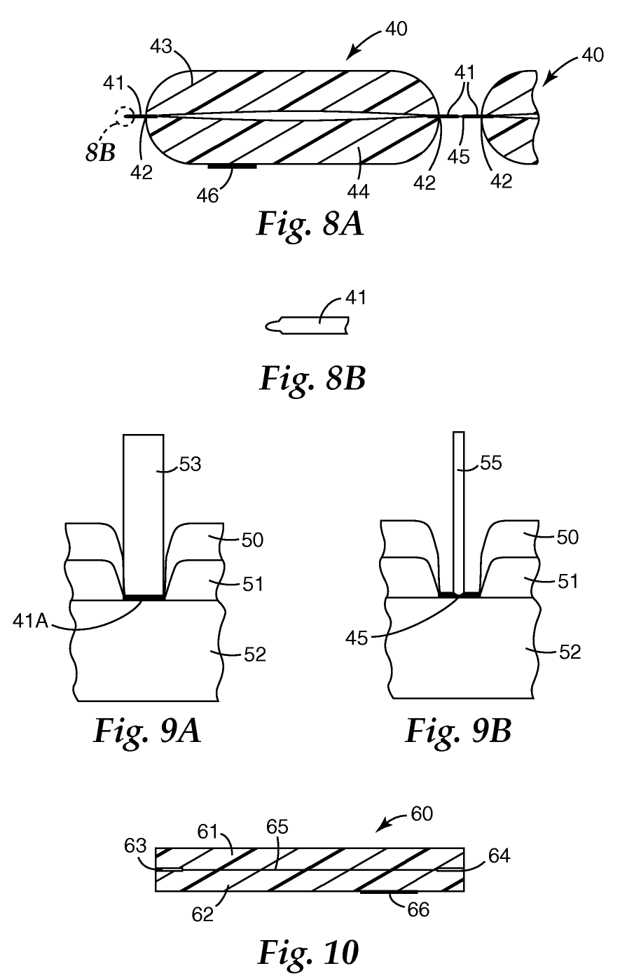

FIG. 8A shows a diagrammatic transverse cross section of part of an alternative array of foam strips 40, each useful as a masking article in accordance with the invention. Each strip 40 is similar to the foam tape 3 of FIGS. 1 and 2 except that it has a land area 41 on each side, extending from the welds 42 that join the two foam layers 43, 44 of the tape together. The land areas 41 of adjacent strips 40 are joined, along their length, by a line of weakness 45 along which the strips 40 can be separated from each other. Each strip 40 is provided with an adhesive stripe 46.

FIG. 8B shows a close-up view of a land area 41 of a strip 40 that has been separated from the array of FIG. 8A.

FIGS. 9A and 9B illustrate a method of forming the land areas 41 and lines of weakness 45 of the array of FIG. 8A. Two sheets 50, 51 of suitable foam material are passed together around a score roller 52 under two successive sets of blunt rotary knives. The rotary knives of the first set (of which only one knife 53 is shown, in FIG. 9A) are equispaced and comparatively wide, and are resiliently-biased towards the score roller 52 with sufficient force to produce a set of wide, parallel, equispaced flattened areas 41A in the foam material. The rotary knives of the second set (of which only one knife 55 is shown) are comparatively narrow and are resiliently-biased towards the score roller 52 with sufficient force to form the lines of weakness 45 in the already flattened areas 41A and bisect the latter into the two land areas 41. It is also possible to run the foam material under the narrow rotary knives first, then subsequently under the wide rotary knives. The method illustrated in FIGS. 9A and 9B has been found to result in stronger welds between the foam sheets 50, 51. For that purpose, the land areas 41 need to have a width of only a few millimeters and should not substantially affect the performance of the masking strips 40 in use.

In foam tapes manufactured as described above with reference to FIGS. 6 and 9A, 9B, the enclosed space 10 within the tape will typically be slightly open when the tape is in its rest condition, as shown for example in FIGS. 1 and 2. This is a consequence of the compression of the foam material that occurs during the cold-welding operation but is not essential. FIG. 10, for example, shows a diagrammatic transverse cross-section of an elongate masking article 60 that comprises two elongate layers of material 61, 62 joined together face-to-face at their longitudinal edges on both sides of the article by adhesive indicated at 63, 64. In this case, the layers 61, 62 and adhesive joins 63, 64 enclose a region 65 where the sheets are unjoined but abut each other in the rest state. An adhesive stripe 66 is provided on the external surface of the layer 62, positioned closer to the adhesive join 64. The cross section of the article 60 is elongated in the direction between the adhesive joins 63, 64 but, unlike that of the tape 3 of FIG. 1, is not rounded at its ends. However, the ends could be rounded if required, for example by chamfering.

The construction of the article 60 (including its cross-sectional dimensions and the physical characteristics of the layers 61, 62) are such that, when pressure is applied on opposite sides of the article to move the adhesive joins 63, 64 towards one another, an enclosed space will open up in the region 65 of the article, similar to the enclosed space 10 in the tape 3 of FIGS. 1 and 2.

Without wishing to be bound by theory, it is believed that the versatility of the masking articles described above with reference to the drawings is related to the fact that the force required to compress the articles by moving their longitudinal edges towards one another is comparatively constant for a large part of that movement. Typically, after a small initial rise in the compression force required to open up the enclosed space within an article, the force required to move the longitudinal edges of the article towards one another remains comparatively constant until the edges almost meet, when it rises again as the enclosed space within the article is finally closed. It is believed that this results in the article being highly conformable to the space in which it is positioned and, consequently, able to fill gaps of different shapes and sizes without being so tight a fit as to prevent manipulation of the masking article while in place or so loose as to be easily displaced by accident.

Based on a knowledge of the most common dimensions and shapes of gaps to be masked, the invention enables masking articles to be produced that are sufficiently versatile to adapt to a variety of those gaps.

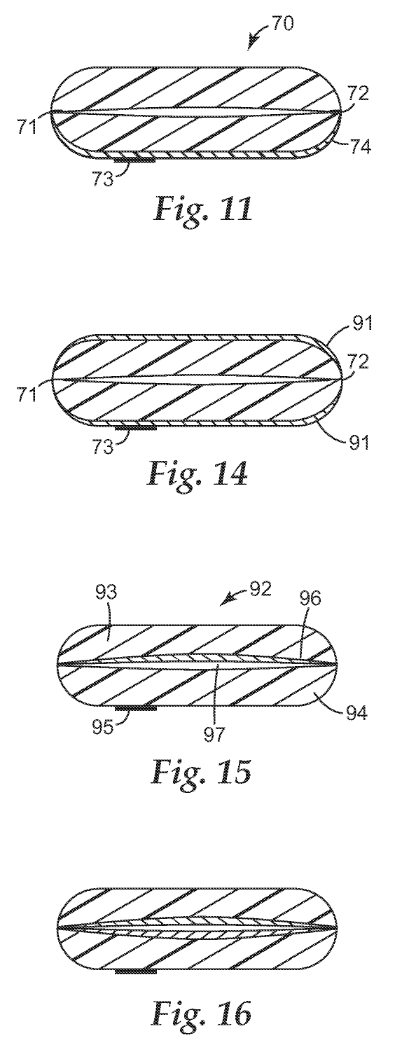

A modification of the foam tape 3 of FIGS. 1 and 2 is illustrated by the transverse cross-section of FIG. 11. In this modified tape 70, the whole of the lower external surface of the tape (between the longitudinally-extending welds 71, 72) on which the adhesive stripe 73 is located comprises an integral skin 74, which gives this surface a smoother texture than the rest of the tape. It has been found that the presence of this skin can result in an improvement in the quality of the paint edge produced on the adjacent surface of the vehicle that is being re-sprayed. More specifically, it has been found that the number of paint speckles that appear along the paint edge (which can give the edge a fuzzy appearance) is reduced by the presence of the skinned surface 74, with consequential benefit to the overall appearance of the re-painted surface. Without wishing to be bound by theory, it is believed that the paint speckles which appear when a conventional foam masking tape is used may be due to the presence of pores on the surface of the foam material due to the cellular nature of the latter, and that the formation of the speckles is inhibited by increasing the smoothness of the surface through the provision of the skin 74. For optimum results, the tape 70 should be applied to the vehicle so that at least a part of the skinned surface faces generally towards the direction from which paint will be applied or, more specifically, lies in the line of sight of the paint spray.

Foam materials having an integral skin are well known: indeed, an integral skin of some sort is formed on the exposed surface of polymeric foam during conventional foaming processes and is often removed by a process known as “skiving” before the foam is put to use. Likewise, an integral skin may be formed on foam articles produced by an extrusion process (see, for example, the BACKGROUND section of U.S. Pat. No. 3,869,832 of Gibb). In the case of thermoplastic polymeric foams, it is known that an integral skin can be produced on the foam material in a controlled manner after manufacture by the application of heat and pressure to the foam as described in U.S. Pat. No. 3,123,656 (Rochlin) and U.S. Pat. No. 3,443,007 (Hardy), or by the application of an additional layer as described in U.S. Pat. No. 2,994,110 (Hardy). The “integral skin” is a higher-density layer at the outer surface of the foam material: it is formed from the same material as the foam and is an integral part thereof but is a distinct area (in other words, an abrupt change can be perceived between the average density of the skin and the average density of the foam material beneath the skin). Depending on the process conditions, the outer surface of the skin may still exhibit the presence of pores, although they will be fewer in number than in an “unskinned” surface (i.e. the outer surface of the skin will be more closed, and smoother).

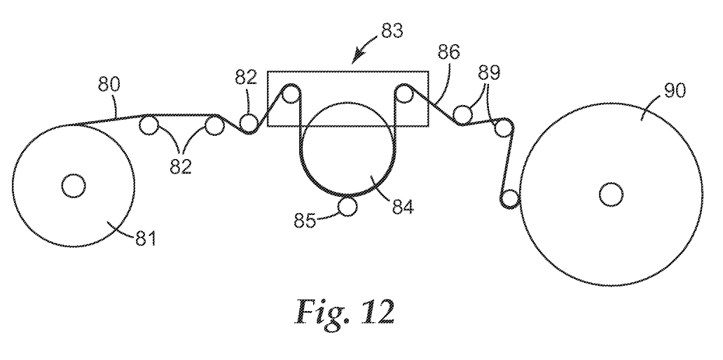

FIG. 12 illustrates the formation of an integral skin in a controlled manner on one surface of a web of thermoplastic polymeric foam material. FIG. 12 shows the web of polymeric foam material 80 being fed from a roll 81, via a series of rollers 82, to a station 83 where an integral skin is formed on the upper surface of the web (as viewed in the drawing).

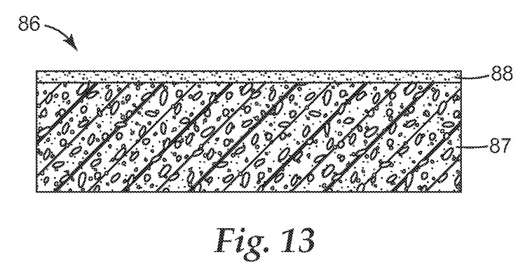

The skin is formed by passing the web around a heated roll 84 and through a nip between the heated roll and a pressure roller 85. The temperature of the heated roll 84 and the pressure exerted by the roller 85 on the web, together with the process speed, are selected to ensure the formation, over the entire surface of the web adjacent the heated roll, of an integral skin having the required thickness and an outer surface with the required degree of smoothness. The skinned web 86 that leaves the station 83 is of reduced thickness and, as illustrated by the cross-sectional view of FIG. 13, comprises a layer 87 of the original foam material with the integral skin 88 on one surface. The skinned web 86 is then allowed to cool, for example during its passage, via a series of rollers 89, to a roll 90 on which it is re-wound.

An array of foam tapes of the type illustrated in FIG. 11 can then be formed using the method described above with reference to FIG. 6 but replacing the sheet 30 of foam material by a sheet of skinned foam as shown in FIG. 13, with the skin 88 outermost. In a further modification of the process, the sheet 31 of FIG. 6 (rather than the sheet 30) is replaced by a sheet of skinned foam as shown in FIG. 13, in this case with the skin 88 adjacent the score roller 32. The process will then result in an array of foam tapes in which the adhesive stripe 73 is located on the unskinned part of the tape, instead of the skinned part as shown in FIG. 11. In yet another modification, both sheets 30, 31 of FIG. 6 have an integral skin, resulting in an array of foam tapes each of the type shown in FIG. 14, having an integral skin 91 over its entire surface.

Particular examples of foam tapes of the type shown in FIG. 11, which have been found suitable for use in masking gaps in cars, have been made as described above using, for the skinned foam, sheets having a nominal thickness of 3.5 mm formed from polyurethane foam having a nominal density of 28 kg/m³ and, for the unskinned foam, sheets having a nominal thickness of 3 mm formed from polyurethane foam having a nominal density of 26 kg/m³ (both available from Caligen Foams Limited, Broad Oak, Accrington, UK). The tapes were produced in widths (i.e. the distance between the welds 67 in FIG. 12) of 22 mm.

Foam masking tapes of the general type described above with reference to FIGS. 11 and 14 are also described in our co-pending UK patent applications No. 0622340.8 (attorney ref. 63280 GB002) of the same date as the present application.

Another modification of the foam tape 3 of FIGS. 1 and 2 is illustrated by the transverse cross-section of FIG. 15. In this modified tape 92, the whole of the internal surface of one of the foam layers 93, 94 from which the tape is formed (in this case, the layer 93 that does not carry the adhesive stripe 95) comprises an integral skin 96. The skin 96 thus faces into the internal space 97 in the tape. It has been found that the presence of this skin reduces the flexibility of the tape and, in some cases, this will result in the handling characteristics of the tape being improved. It will be appreciated that an array of tapes of the type shown in FIG. 15 can be formed using the method described above with reference to FIG. 6 but replacing the sheet 31 of foam material by a sheet of skinned foam as shown in FIG. 13, with the skin 88 innermost. In a further modification of the process, the sheet 30 of FIG. 6 (rather than the sheet 31) is replaced by a sheet of skinned foam as shown in FIG. 13, again with the skin 88 innermost. The process will then result in an array of foam tapes similar to that of FIG. 15 except that skin is located on the internal surface of the foam layer 94. In yet another modification, both sheets 30, 31 of FIG. 6 have an integral skin and the skins are located adjacent each other, resulting in an array of foam tapes each of the type shown in FIG. 16.

Foam tapes of the type described above, although particularly suitable for masking gaps, can also be used to mask swage lines on vehicles (i.e. lines where there is a change in contour in the vehicle bodywork) in preparation for spray painting. In that case also, the presence of a skinned surface 74 as described above with reference to FIG. 11 may enable an improvement to be obtained in the quality of the paint edge, along the swage line, between the area of the vehicle bodywork that is being painted and the adjacent area. In this case also, for optimum results, the tape should be applied to the vehicle so that at least a part of the skinned surface faces generally towards the direction from which paint will be applied or, more specifically, lies in the line of sight of the paint spray. Additionally, foam tapes as described above may be used for blending newly-applied paint on regions of a vehicle body surface into regions having the original paint. For example, where a small repair has been done on a panel, it may be unnecessary to respray the whole panel.

A masking article in accordance with the invention may be made of any material known to be suitable for masking gaps in vehicles, preferably a material that is sufficiently flexible and elastic to allow it to be manipulated without buckling around bends in the gap that is being masked, such as where a car door closes around and adjacent to the rear wheel arch. There is then no need to cut separate lengths of the masking article to mask curves or corners in a gap with the consequent risk of poor continuity in the paint edge at the abutments between the separate lengths. Suitable polymeric foam materials for masking articles include polystyrene, polyvinylchloride, polyethylene, thermoplastic or thermosetting polyurethane, polypropylene, polyester and silicone foams, with thermoplastic foams being selected for articles in which the foam comprises an integral skin. Preferred materials are cold-weldable polymeric foams enabling an array of masking articles to be produced comparatively simply and economically, using a method of the type described above with reference to FIG. 6.

The joins along the longitudinal edges of the masking article (such as the joins 6, 7 of FIG. 1) may, instead of being formed by cold welding or an adhesive as already described, be formed using adhesive tape (such as double-sided adhesive tape or transfer tape), by directing a jet of hot air at the surfaces to be joined, by through-transmission infrared TTIR welding, by ultrasonic welding, or in any other suitable way. The joins may be continuous along the length of the masking article but could, alternatively, be discontinuous provided this does not affect the performance of the article when being used to mask a gap in a vehicle.

Alternatively, it is also possible to form a masking article in accordance with the invention in one piece, for example by extrusion. In that case, there would be no need for the two layers of material that define the enclosed space within the article to be joined together in a separate operation.

The layers of material that make up a masking article in accordance with the invention (such as the layers 4, 5 of FIG. 1) may be of the same thickness and materials, although that is not essential: different thicknesses and materials may be employed as required to provide the masking article with desired characteristics. The masking article can be coloured to provide a visual indication of its characteristics and it is also possible for the layers of material that make up the article to be differently-coloured to assist in accurately positioning the article on a surface of a vehicle.

In the preferred case in which the masking article is formed from a cold-weldable polymeric foam, the foam material employed may be an open or closed cell foam that is resiliently compressible for conforming to a required shape for a given application. The density of the foam should be selected to ensure that cold welds of adequate strength can be achieved.

The attachment of a masking article in accordance with the invention to a vehicle may be achieved by using pressure-sensitive adhesive as described above, or in any other suitable way including, for example, by magnetic attraction e.g. using a thin magnetic strip embedded in part of the masking article. When a pressure-sensitive adhesive is employed, it should be capable of adhering to the foam material of the tape, and to the bodywork of a vehicle. When the foam tapes are packaged in the form of a roll, the surface of the tape opposite the adhesive may be coated with a release material to prevent the adhesive on the tapes in one layer of the roll adhering to the tapes in an adjacent layer of the roll. Any suitable release material may be used for that purpose. Whatever form of attachment is used, it should permit flexing of the masking article whilst being secure enough to withstand the pressure wave created by closing a movable part of the vehicle onto it and to withstand any post-treatment of the paint (e.g. baking). The attachment point is preferably positioned on a flat region of the surface of the masking article, and preferably away from the longitudinal edge of the masking article that will be pushed by the action of closing parts of the vehicle together. In the case in which an adhesive is used to attach the masking article to the surface of a car, such a location makes it possible to ensure that the adhesive is not exposed by the action of closing parts of the vehicle together, thereby eliminating the risk of a hard edge being created where paint accumulates against the edge of the adhesive. However, the location of the attachment point is a matter of choice and should be selected having regard to the intended use of the masking article.

1. An elongate masking article suitable for removable-attachment to a vehicle for masking a gap between two relatively-movable parts of the vehicle, the masking article having an elongate transverse cross-section and being so constructed that an enclosed space can be opened up within the article by applying pressure on opposite sides of the article to reduce the length of its transverse cross section, whereby the article is able to deform to fill the said gap.

2. A masking article as claimed in claim 1, in which the enclosed space is located between two layers of material that are arranged face-to-face and join with one another along the said opposite sides of the article.

3. A masking article as claimed in claim 1, in which the enclosed space is located between two layers of material that are arranged face-to-face and joined together along the said opposite sides of the article.

4. A masking article according to claim 3, in which the layers are joined together by welds.

5. A masking article according to claim 4, in which the welds are cold welds.

6. A masking article according to claim 2, in which the said layers are of the same thicknesses.

7. A masking article according to claim 1, the article being formed from polymer foam.

8. A masking article according to claim 7, in which the polymer foam has an integral skin over at least a lengthwise extending part of the article.

8. A masking article as claimed in claim 8, in which the integral skin is located on an external surface of the article.

9. A masking article according to claim 9, in which the position of the integral skin on the article is such that, when the article is attached to a vehicle for masking a surface to be painted, at least a part of the skin will face generally towards the direction from which paint will be applied.

10. A masking article as claimed in claim 8, in which the integral skin is located on an internal surface of the article, facing the enclosed space.

11. A masking article according to claim 1, in which pressure-sensitive adhesive is provided on an external surface of the article for removably-attaching the article to a part of a vehicle.

12. A masking article according to claim 11, in which the adhesive is in the form of a stripe along the length of the article.

13. A masking article according to claim 12, in which the adhesive is positioned closer to one of the said opposite sides of the masking article than to the other.

14. A masking article according to any one of claim 12, comprising a release coating on the external surface of the article, opposite the adhesive, to prevent the article adhering to itself when wound in a roll.

15. A method of producing the article of claim 1, including the steps of providing two webs of polymeric foam, positioning the webs face-to-face with the skin facing outwards, and compressing and welding the two webs together along a pair of spaced parallel lines.

16. A method as claimed in claim 15, in which at least one of the webs has an integral skin over at least one of its surfaces.

17. A method of using the article of claim 1 for masking a gap between two relatively-movable parts of a vehicle in preparation for spray painting, the method comprising attaching the article to one of the parts and then bringing the parts together with the article positioned in the gap between them.

18. A method according to claim 17, further comprising adjusting the position of the masking article when positioned in the gap between the parts.

19. A method of using the article of claim 1 for masking a swage line on a vehicle in preparation for spray-painting, the method comprising the step of attaching the article to the surface of the vehicle so that it extends along the swage line.

20. A method as claimed in claim 18, in which the article is as claimed in claim 9, including the step of positioning the article so that at least a part of the skin faces generally towards the direction from which paint will be applied.
